(19) United States
(12) Patent Application Publication
(10) Pub. No.: US 2010/0140851 A1
(43) Pub. Date: Jun. 10, 2010

(54) In-Mould Coating Method

(76) Inventor: Yu-Syuan Jin, Tucheng City (TW)

Correspondence Address: Dr. BANGER SHIA;Patent Office of Bang Shia, 102 Lindencrest Ct., Sugar Land, TX, 77479-5201, US

(21) Appl. No.: 12/704,660

(22) Filed: Feb. 12, 2010

Related U.S. Application Data
(63) Continuation-in-part of application No. 12/049,271, filed on Mar. 15, 2008.

(30) Foreign Application Priority Data
Mar. 20, 2007 (TW) 096109478

(51) Int. Cl. B29C 45/16

(52) U.S. Cl. 264/447

(57) ABSTRACT

An in-mould coating method and a coating device for the same, wherein the inserts in the mould of the coating device are made of transparent material and are each coated with reflective material. In each insert are installed light generators, light sensors, cameras, etc. The coating method comprises the steps of: closing the mould after placing a semi-finished product formed by injection molding or other processes in the mould; injecting liquid lacquer or other liquid coating material, and using the cameras to monitor filling; and after finishing filling, starting the light generators and utilizing the light sensors to monitor the amount of light irradiated on the injected liquid lacquer or other liquid coating materials in such a manner that the injected liquid lacquer or other liquid coating materials is hardened to form a coating film on the surface of the semi-finished product.

This application is a continuation of part of U.S. patent application Ser. No. 12/049,271, which claims the benefit of the earlier filing date of Mar. 15, 2008. Claim 1 of this application is revised from the U.S. patent application Ser. No. 12/049,271.

### BACKGROUND OF THE INVENTION

1. Field of the Invention

The present invention relates to an in-mould coating method, and more particularly to an in-mould coating method, which can form a coating film on the surface of a semi-finished product in mould by irradiating a liquid lacquer or other liquid coating materials injected into the mould.

2. Description of the Prior Art

A conventional in-mould coating method (disclosed in TW Patent Application No. 093135078) is heating liquid lacquer to harden it by use of heating wire or other heating methods to form a coating film on the surface of an injection molding semi-finished product. However, the above conventional method has the following disadvantages: it is required to additionally develop a thermosetting liquid lacquer and; it is likely to cause uneven control temperature and uneven hardening: when the heating wire or other heating methods is used, the liquid lacquer is heated to solidify via steel mould insert by heat conduction in such a manner that the coating film can be combined on the surface of the injection molding product.

The present invention has arisen to mitigate and/or obviate the afore-mentioned disadvantages.

### SUMMARY OF THE INVENTION

The primary objective of the present invention is to provide a method which can apply a liquid lacquer capable of being hardened by the light within the range from the invisible light to the visible light or a common thermosetting liquid lacquer to form a coating film on a semi-finished product formed by injection molding or other processes in mould.

The present invention injects a predetermined amount of liquid lacquer or other liquid coatings in the mould and then irradiates a predetermined amount of light to harden it, so that the semi-finished product placed in the mould can be coated with a coating film on the surface thereof.

In order to achieve the above objectives, the inserts of the mould are made of transparent material (such as quartz, glass, crystal, etc). In the transparent insert are installed at least one light generator (such as UV light, infrared ray, etc), cameras, light sensors, cooling water pipes, etc. The transparent insert is coated with a reflective layer on the outer surface thereof. A bolster is attached to the bottom of the transparent insert for fixing the cameras and the light sensors.

### BRIEF DESCRIPTION OF THE DRAWINGS

FIG. 1 is a longitudinal cross-sectional view of: a mould in accordance with the present invention; and

FIG. 2 is a longitudinal cross-sectional view of another in-mould coating device in accordance with the present invention

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

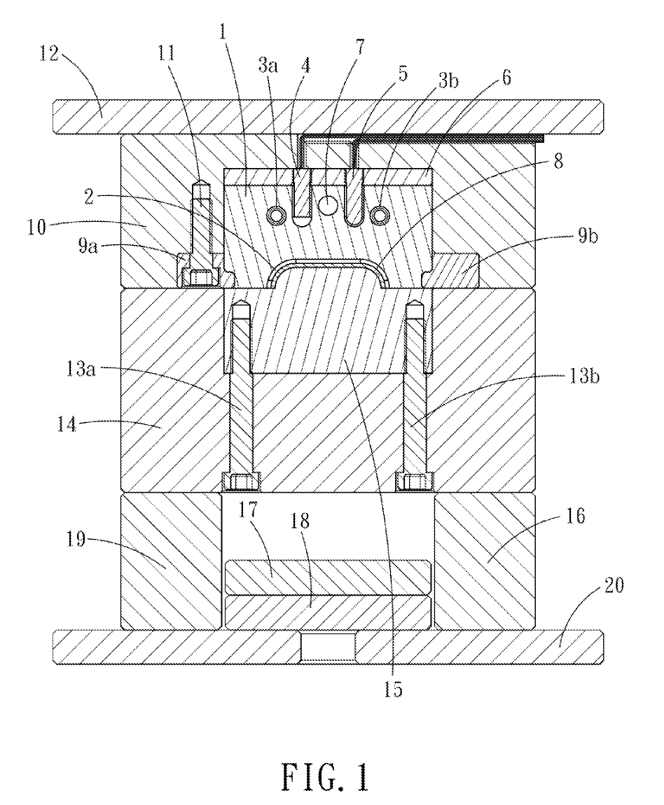

Referring to FIG. 1 a mould in accordance with a preferred embodiment of the present invention comprises: a fixed plate 10, a moving plate 14, a fixed insert 1, a moving insert 15, insert-fixing plates 9a, 9b, a fixed retainer 12, a moving retainer 20, spacer blocks 16, 19, an upper ejector plate 17, and an lower ejector plate 18. The fixed insert 1 is also fixed in the cavity of the fixed plate 10 by a plurality of screws 11 in the same way of the conventional one, but the difference is that, a bolster 6 should be attached to the bottom of the fixed plate 10 in advance, and then the fixed plate 10 is fixed. The moving insert 15 is directly locked on the moving plate 14 by a plurality of screws 13a, 13b. Additionally, the fixed insert 1 of the present invention is made of transparent material (such as quartz, glass, crystal, etc) and then coated with a reflective layer on the outer surface thereof. After that, more than one light generator is assembled inside the fixed insert 1 according to the requirements of the mould design. At the same moment, after being further fixed in advance with more than one camera 4 and more than one light sensor 5, the above bolster 6 is inserted in the transparent fixed insert 1, and the plurality of screws 11 is then used to lock the fixed insert 1 to the fixed plate 10. After the transparent fixed insert 1 is locked, its inner equipments, such as the light generators 3a, 3b, the cameras 4 and the light sensors 5, will be equipped with the on-off and control wires, finishing the assembly of the in-mould coating device of the present invention.

To summarize, when the mould of the present invention performs the coating on the surface of an injection molding semi-finished product 8 to form a coating film, the injection molding semi-finished product 8 is placed on the moving insert 15 of the mould first (as shown in FIG. 1). Subsequently, the mould will be closed, the liquid lacquer or other liquid coating materials will be injected into the clearance between the transparent fixed insert 1 and the injection molding semi-finished product 8, (the liquid lacquer or other liquid coating material is a photosensitive material which can be hardened to form a coating film when subjected to light radiation and can produce different colors in different areas of the coating film by changing the amounts of light generated from the light generators) and the camera 4 will be used to monitor the filling state. After the injection is finished, the light generators 3a, 3b will be started, and the light sensor 5 will be used to monitor the amount of light irradiated on the injected liquid lacquer or other liquid coating materials. After the complete hardening of the liquid lacquer, a coating film 2 can be formed on the outside surface of the injection molding semi-finished product, achieving the desired appearance and function of the finished product.

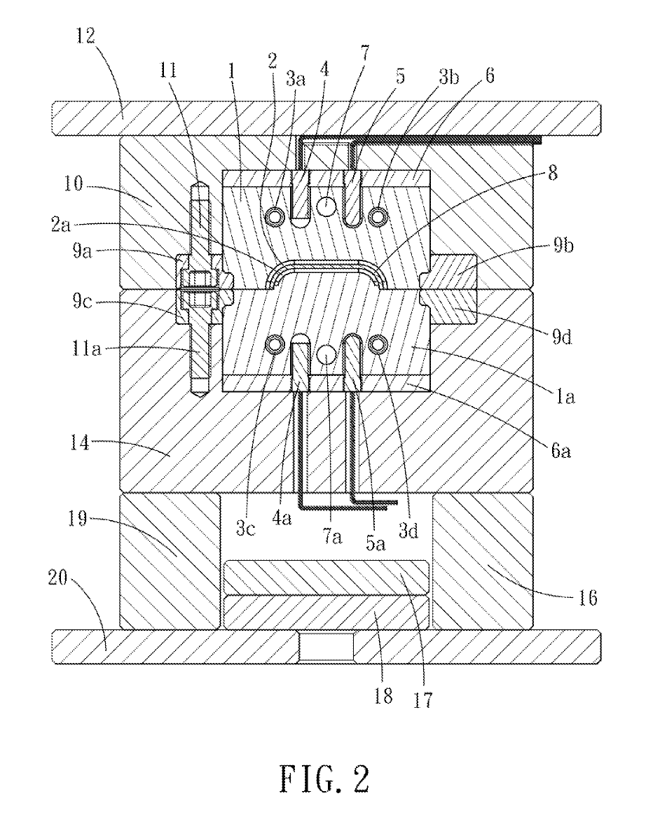

Further, FIG. 2 shows an in-mould coating device in accordance with another embodiment of the present invention. The in-mould coating device of the present invention is assembled on a moving insert 1a of an injection mould, and the moving insert 1a is made of transparent material as described above and coated with a reflective layer on the outer surface thereof. After that, a predetermined number of light generators 3c, 3d, cameras 4a and light sensors 5a are installed in the transparent moving insert 1a, and then the on-off and control wires will be equipped (not shown). Finally, the bolster 6a fixed with the cameras 4a and the light sensors 5a is attached to the bottom of the moving insert 1a, and the insert-fixing plates 9c, 9d are then used to lock the moving insert 1a in the cavity of the moving plate 14 by a plurality of screws 11a, finishing the assembly of the in-mould coating device of the present invention. Thereby, by applying the above method, an injection molding semi-finished product 8 is placed on the moving insert 1a, and the liquid lacquer or other liquid coating materials is injected into the clearance therebetween for coating the “inside surface” of the injection molding semi-finished product 8 with a coating film 2a. For the same reason, the in-mould coating device of the present invention can also be as shown in FIG. 2 completely, and the device is on both the fixed insert 1 and the moving insert 1a. By such arrangements, the above method can be used to form a coating film 2, 2a on each of the “inside” and the “outside” surfaces of an injection molding semi-finished product 8 synchronously.

Additionally, an injection molding semi-finished product 8 is placed on the transparent fixed insert 1 or moving insert 1a of the mould of the present invention by the following two ways. 1. Forming a semi-finished product 8 by injection molding or other processes (such as extrusion molding process, or vacuum forming process, etc), then placing the semi-finished product 8 on the transparent fixed or moving inserts 1, 1a of the present invention; 2. By way of double injection moulds, fixing both the injection mould of semi-finished product and the mould of the present invention on an injection molding machine capable of rotating or moving; next, forming an injection semi-finished product 8 first by the injection mould of semi-finished product, and then placing the injection semi-finished product 8 on the transparent fixed or moving inserts 1, 1a of the injection mould of the present invention after mould opening; and finally, closing mould again. In addition, the representative symbols 7, 7a as shown in FIGS. 1-2 are the cooling water pipes of the injection moulds in accordance with two embodiments of the present invention, respectively.

In addition, the in-mould coating device of the present invention can also be obtained by the methods as follows:

1. More than one light generator 3a, 3b, 3c, or 3d on the in-mould coating device of the present invention can also be on other mould parts besides the transparent fixed or moving inserts 1 or 1a.

2. The in-mould coating device of the present invention can be provided with a predetermined number of concaves or protrusions in a predetermined shape at the outer surface of the finished product of the fixed or moving inserts 1 or 1a for adequately reflecting the light from the light generators 3a, 3b or 3c to the surface of the semi-finished product 8.

3. If the injection molding semi-finished product 8 has hooks or a complicated shape or configuration, the fixed or moving inserts 1 or 1a of the in-mould coating device of the present invention can be provided with other demoulding mechanisms (not shown), which can also be made of transparent material such as quartz, glass, crystal (if necessary).

While we have shown and described various embodiments in accordance with the present invention, it is clear to those skilled in the art that further embodiments may be made without departing from the scope of the present invention.

What is claimed is:

1. An in-mould coating method comprising the steps of:
placing a semi-finished product formed by injection molding or other processes on a moving insert of a mould;
injecting a liquid lacquer or other liquid coatings into a clearance between a transparent fixed insert and the semi-finished product after mould closing;
utilizing cameras to monitor filling state; and
after finishing filling, starting light generators and using light sensors to monitor amount of light irradiated on the liquid lacquer or other liquid coating materials, causing a chemical hardening to form a coating film on a surface of the semi-finished product, thus obtaining a desired finished product;
wherein the in-mould coating method is characterized in that: the liquid lacquer or other liquid coating material is a photosensitive material which can be hardened to form a coating film when subjected to light radiation and can produce different colors in different areas of the coating film by changing the amounts of light generated from the light generators.
